(19) United States
(12) Patent Application Publication
(10) Pub. No.: US 2026/0017197 A1
(43) Pub. Date: Jan. 15, 2026

(54) CACHE ALLOCATION METHOD AND APPARATUS, AND ELECTRONIC DEVICE

(71) Applicant: Smarter Silicon (Shanghai) Technologies Co., Ltd., Shanghai (CN)

(72) Inventor: Zhongsong LIN, Shanghai (CN)

(21) Appl. No.: 19/338,621

(22) Filed: Sep. 24, 2025

Related U.S. Application Data
(63) Continuation of application No. PCT/CN2023/134622, filed on Nov. 28, 2023.

(30) Foreign Application Priority Data
Mar. 24, 2023 (CN) 202310301544.0

(51) Int. Cl. G06F 12/0802

(52) U.S. Cl. CPC G06F 12/0802

(57) ABSTRACT

A cache allocation method includes: determining multiple candidate memory buffers; determining a target memory buffer among the multiple candidate memory buffers whose attribute information meets a preset requirement, wherein the attribute information is related to a usage frequency of corresponding candidate memory buffer; and locking a corresponding cache area within a cache for the target memory buffer to cache data in the target memory buffer.

### CROSS-REFERENCE TO RELATED APPLICATION(S)

This application claims priority to PCT International Application No. PCT/CN2023/134622 filed on Nov. 28, 2023, which in turn claims priority to Chinese Patent Application No. 202310301544.0 filed on Mar. 24, 2023, both of which are incorporated herein by reference in their entireties.

### FIELD OF THE TECHNOLOGY

Certain embodiments of the present disclosure relate to electronic technology, and in particular to a cache allocation method and an apparatus, and an electronic device.

### BACKGROUND

Electronic devices are widely used, and various types of storage modules exist in electronic devices, playing an important role in the normal operations of electronic devices. In particular, a system-level cache of electronic devices plays an irreplaceable role in electronic devices.

### SUMMARY

In one aspect, the present disclosure provides a cache allocation method. The method includes: determining multiple candidate memory buffers; determining a target memory buffer among the multiple candidate memory buffers whose attribute information meets a preset requirement, where the attribute information is related to a usage frequency of corresponding candidate memory buffer; and locking a corresponding cache area within a cache for the target memory buffer to cache data in the target memory buffer.

In another aspect, the present disclosure provides an electronic device. The device includes: a memory storing computer program instructions; and a processor coupled to the memory and configured to execute the computer program instructions and perform: determining multiple candidate memory buffers; determining a target memory buffer among the multiple candidate memory buffers whose attribute information meets a preset requirement, where the attribute information is related to a usage frequency of corresponding candidate memory buffer; and locking a corresponding cache area within a cache for the target memory buffer to cache data in the target memory buffer.

In yet another aspect, the present disclosure provides a non-transitory computer-readable storage medium storing computer program instructions executable by at least one processor to perform: determining multiple candidate memory buffers; determining a target memory buffer among the multiple candidate memory buffers whose attribute information meets a preset requirement, where the attribute information is related to a usage frequency of corresponding candidate memory buffer; and locking a corresponding cache area within a cache for the target memory buffer to cache data in the target memory buffer.

### BRIEF DESCRIPTION OF THE DRAWINGS

FIG. 1 is a schematic diagram of an implementation flow of a cache allocation method according to certain embodiments of the present disclosure;

FIG. 2 is a schematic diagram of an implementation flow of a cache allocation method according to certain embodiments of the present disclosure;

FIG. 3A is a schematic diagram of an operation of an OCM mode in certain related technology;

FIG. 3B is a schematic diagram of an operation of an OCM mode according to certain embodiments of the present disclosure;

FIG. 4 is a schematic diagram of a structure of a cache allocation device according to certain embodiments of the present disclosure;

FIG. 5 is a schematic diagram of a structure of an electronic device according to certain embodiments of the present disclosure; and

FIG. 6 is a schematic diagram of a hardware entity of an electronic device according to certain embodiments of the present disclosure.

### DETAILED DESCRIPTION

The technical solutions of the present disclosure are described below in conjunction with the accompanying drawings. Certain embodiments as described reflect some of the embodiments of the present disclosure but not all of them. Other embodiments derived by persons of ordinary skill in the technical field based on certain embodiments of the present disclosure without inventive effort are within the scope of protection of the present disclosure.

In the following description, references to “certain embodiments” describe a subset of all possible embodiments. However, “certain embodiments” may refer to the same subset or different subsets of all possible embodiments, and may be combined without conflict.

In the following description, suffixes such as “module,” “component,” or “unit” used to denote components are used to facilitate the description of the present disclosure and do not inherently have particular meanings. Therefore, “module,” “component,” or “unit” may be used interchangeably.

Terms “first,” “second,” and “third” used in certain embodiments of the present disclosure are used to distinguish similar objects and do not necessarily represent any particular ordering of the objects. The order or sequence of “first,” “second,” and “third” may be interchanged where permitted, so that certain embodiments described herein may be implemented in an order other than that illustrated or described herein.

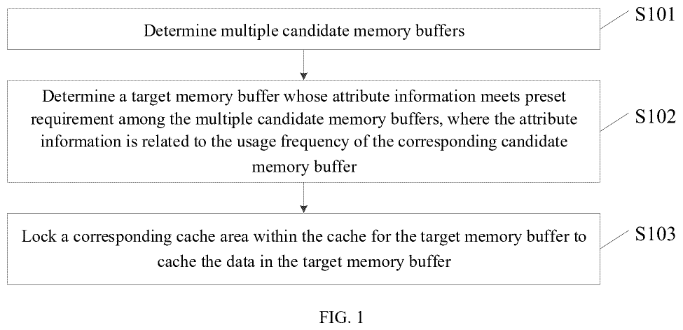

Certain embodiments of the present disclosure provide a method for cache allocation. The functions implemented by this method may be implemented by calling program code by a processor in an electronic device. The program code may be stored in the storage medium of the electronic device. FIG. 1 is a schematic diagram of an implementation flow of a cache allocation method of certain embodiments of the present disclosure. As shown in FIG. 1, the method includes:

S101: Determine multiple candidate memory buffers.

Here, the electronic device may be any type of device with information processing capabilities, such as a navigation system, a smartphone, a tablet computer, a wearable device, a laptop computer, an all-in-one computer, a desktop computer, a server cluster, or the like.

An electronic device may include multiple storage modules, such as cache, memory, external memory, or the like. Among them, the memory buffer refers to a memory segment used in the system, which is used to place a complete system resource of the operating system, such as Frame Buffer. The memory may be DDR (Double Data Rate), SDRAM (Synchronous Dynamic Random Access Memory), DRAM (Dynamic Random-Access Memory), or the like, and the candidate memory buffer may be a memory segment in DDR or a memory segment in DRAM. In certain embodiments of the present disclosure, there are multiple memory buffers, and the memory buffers that meet the preset condition are used as candidate memory buffers; of course, there are multiple candidate memory buffers. Among them, the preset condition includes but is not limited to: there is no memory buffer whose corresponding cache area is locked.

S102: Determine as a target memory buffer a candidate memory buffer whose attribute information meets preset requirement among the multiple candidate memory buffers, where the attribute information is related to the usage frequency of the corresponding candidate memory buffer.

In certain embodiments of the present disclosure, the method includes determining a target memory buffer from among the multiple candidate memory buffers, where the determination is based on the attribute information of each candidate memory buffer, where the attribute information is related to the usage frequency of the corresponding candidate memory buffer.

In certain embodiments, the attribute information includes, but is not limited to, one or more of: memory buffer usage frequency, memory buffer update area size, memory buffer update frequency, and the pixel byte value of the memory buffer format.

The memory buffer usage frequency may be comprehensively evaluated using multiple attribute information. For example, the score of a corresponding candidate memory buffer may be determined by multiplying the memory buffer usage frequency, the memory buffer update area size, and the memory buffer format pixel byte value. A candidate memory buffer with a score greater than a preset threshold may be determined as a target memory buffer. For another example, the score of a corresponding candidate memory buffer may be determined by summing the memory buffer usage frequency and the memory buffer update area size. A candidate memory buffer with a score greater than a preset threshold may be determined as a target memory buffer.

In certain embodiments of the present disclosure, the implementation method for the attribute information to meet the preset requirements is not limited. As long as a target memory buffer is determined from multiple candidate memory buffers based on the attribute information of the candidate memory buffers, it is within the scope of protection of the present disclosure.

S103: Lock a corresponding cache area within the cache for the target memory buffer to cache the data in the target memory buffer.

In certain embodiments of the present disclosure, after determining the target memory buffer, a corresponding cache area may be locked for the target memory buffer in a cache (such as a system level cache SLC) to cache the data in the target memory buffer, so that the processor may directly obtain the corresponding data from the cache area without having to obtain the corresponding data from the main memory, thereby improving the processing efficiency of the processor.

For example, due to the influence of process and/or power consumption, the system-level cache is much smaller than the main memory (such as DDR). For example, the size of the system-level cache is generally several megabytes or tens of megabytes, while the DDR main memory is generally on the order of several or tens of gigabytes. The cache allocation method provided in certain embodiments of the present disclosure may dynamically determine which DDR memory segment in the cache SLC to lock the corresponding cache area based on the attribute information of different DDR memory segments (memory buffers) to cache the data in the DDR memory segment, so that the processor (such as a central processing unit, a graphics processing unit, or the like) may directly and quickly read the data. In other words, the buffer and the cache belong to two different hardware entities, and locking refers to locking a cache area in the SLC, which is particularly used to store data originally in the target buffer of the DDR.

In certain embodiments, through the method described in S101 to S103, the buffer to which the cache area is allocated may be dynamically designated and switched, thereby improving the data hit rate within the cache area at the system level (for example, the probability that the processing unit may directly obtain the required data from the cache without having to retrieve it from the memory).

Certain embodiments of the present disclosure further provide a cache allocation method, which is applied to an electronic device and includes:

S111: Determining a screening condition based on the available size of the cache;

S112: Determining a memory buffer that meets the screening condition as a candidate memory buffer.

In certain embodiments of the present disclosure, memory buffers in unlocked cache areas may be filtered, with memory buffers in unlocked cache areas that meet the screening condition being selected as candidate memory buffers. The screening condition may be determined based on the available size of the cache, and memory buffers that meet the screening condition may be selected as candidate memory buffers.

For example, after determining the available size of the cache, memory buffers whose width and height are greater than 720×480 (bytes) and whose overall size is smaller than the available size may be selected as candidate memory buffers.

For another example, after determining an initial candidate memory buffer whose width and height are greater than 720×480 (bytes) and whose overall size is less than the available size, multiple initial candidate memory buffers may be further screened to obtain a final candidate memory buffer. The screening condition for this second screening include at least one of the following: the size of the memory buffer is less than or equal to a first preset size, where the first preset size is the available size of the cache; updates to the memory buffer exist; the size of the update area of the memory buffer is greater than or equal to a second preset size; and the memory buffer is used to store data to be displayed.

S113: Determine as a target memory buffer a candidate memory buffer among the multiple candidate memory buffers whose attribute information meets the preset requirement, where the attribute information is related to the usage frequency of the corresponding candidate memory buffer;

S114: Lock a corresponding cache area within the cache for the target memory buffer to cache the data within the target memory buffer.

The cache allocation method described at S111 through S114 allows for the dynamic designation and switching of buffers to which cache areas are allocated, while excluding memory buffers that do not meet certain requirements (for example, excluding memory buffers that cannot be locked due to size constraints and memory buffers that have not been updated and therefore do not need to be locked). This improves the data hit rate within the cache and allocation efficiency at the system level.

In certain embodiments, the screening condition includes at least one of:

The first type is that the size of the memory buffer is less than or equal to a first preset size, which is the available size of the cache;

The second type is that there is an update to the memory buffer;

The third type is that the size of an update area of the memory buffer is greater than or equal to a second preset size;

In certain embodiments, the second preset size may be 720×480 (bytes).

The fourth type is that the memory buffer is used to store data to be displayed.

In certain embodiments, a memory buffer used to store data to be displayed refers to a memory buffer used to store data to be displayed on the screen, such as display data, video data, or the like. Because attribute information in certain embodiments of the present disclosure is obtained through a window manager, the candidate memory buffer may be a memory buffer used to store data to be displayed. When the attribute information of the memory buffer is obtained through other methods, the corresponding screening condition may be modified accordingly.

Embodiments of the present disclosure further provide a cache allocation method, applied to an electronic device, the method including:

S121: Determine multiple candidate memory buffers;

S122: Determine a refresh parameter for each candidate memory buffer based on attribute information of each candidate memory buffer among the multiple candidate memory buffers.

S123: Determine the candidate memory buffer whose refresh parameter meets the first requirement as the target memory buffer, where the attribute information is related to the usage frequency of the corresponding candidate memory buffer.

In certain embodiments, the refresh parameter of the candidate memory buffer may be determined based on attribute information such as the refresh frequency and usage frequency of the candidate memory buffer, and the candidate memory buffer whose refresh parameter meets the first requirement is then determined as the target memory buffer.

For example, a candidate memory buffer whose refresh parameter exceeds a preset threshold may be determined as the target memory buffer.

S124: Lock a corresponding cache area within the cache for the target memory buffer to cache the data within the target memory buffer.

In certain embodiments, the cache allocation method at S121 to S124 may dynamically designate and switch the buffer to which the cache area is allocated based on the buffer's refresh parameter. This allows frequently updated buffers to be locked and less frequently used buffers to be flushed, thereby improving the data hit rate within the cache at the system level.

In certain embodiments, the attribute information includes at least one of: a memory buffer update frequency, a size of an update area of the memory buffer, and pixel byte values of a memory buffer format.

In certain embodiments S122, determining the refresh parameters of each candidate memory buffer based on the attribute information of each candidate memory buffer, includes:

Determining the refresh parameters of each candidate memory buffer based on at least one of: the update frequency of each candidate memory buffer, the size of the update area of each candidate memory buffer, and pixel byte values of a memory buffer format.

In certain embodiments, the candidate memory buffer is used to store displayable data, and the pixel byte value of the memory buffer format refers to the Byte Per Pixel value of the memory buffer format, such as 4 for the RGBA format and 1.5 for the NV12 format. Furthermore, the refresh parameter may be determined based on one or more information among the update frequency of the buffer, the size of the update area of the buffer and the pixel byte value of the buffer format. For example, the refresh parameter of the first candidate memory buffer may be the product of the update frequency of the first candidate memory buffer, the size of the update area of the first candidate memory buffer and the pixel byte value of the format of the first candidate memory buffer. Furthermore, the first requirement may be that the refresh parameter is greater than a preset threshold Th, and the preset threshold Th may be calculated by the following formula:

$$Th = Width\_Min * Height\_Min * Fromat\_BPP * VSYNC\_Freq * Refresh\_Ratio ;$$

Where, VSYNC_Freq is the current refresh rate of the display in the system, such as 30 Hz (Hertz), 60 Hz, 120 Hz, or the like; Width_Min and Height_Min are defined constants. For example, during use, the width and height of the update area of the buffer may be greater than 720×480 (bytes), then Width_Min=720, Height_Min=480; Format_BPP is the Byte Per Pixel value of the buffer format, such as 4 for RGBA format and 1.5 for NV12 format; Refresh_Ratio is a system-defined constant, which represents the refresh rate threshold. Usually a floating-point number between 0-0.4 is used. The particular value may be determined based on the actual usage scenario. For example, Refresh_Ratio=0.1 represents that SLC may be used when the refresh frequency is displayed once every ten frames; * is the product symbol.

Certain embodiments of the present disclosure provide a cache allocation method, applied to an electronic device, the method including:

S131: Determine multiple candidate memory buffers;

S132: Determine a refresh parameter for each candidate memory buffer based on

attribute information of each candidate memory buffer, where the attribute information is related to the usage frequency of the corresponding candidate memory buffer;

S133: Sort the multiple candidate memory buffers according to the refresh parameter to obtain a sorting result;

S134: Based on the sorting result, the candidate memory buffer whose sorting position meets the second requirement is determined as the target memory buffer.

In certain embodiments, the multiple candidate memory buffers may be sorted based on the refresh parameter, and the top N candidate memory buffers in the sorting result are determined as the target memory buffer; N may be dynamically determined based on project needs and the current state of the electronic device.

S135: Lock a corresponding cache area for the target memory buffer within the cache to cache the data in the target memory buffer.

Certain embodiments of the present disclosure provide a cache allocation method, applied to an electronic device, the method including:

S141: Determine multiple candidate memory buffers;

S142: Determine a refresh parameter for each candidate memory buffer based on attribute information of each candidate memory buffer, where the attribute information is related to the usage frequency of the corresponding candidate memory buffer;

S143: Determine a refresh parameter threshold based on the storage attributes of the electronic device;

In certain embodiments, the storage attributes include, but are not limited to, the current refresh rate of the system display, the Byte Per Pixel value of the buffer format, and system-defined constants (such as the standard buffer size and the standard refresh rate).

S144: Determine the candidate memory buffer whose refresh parameter is greater than or equal to the refresh parameter threshold as the target memory buffer.

S145: Lock the corresponding cache area within the cache for the target memory buffer to cache the data in the target memory buffer.

In certain embodiments, when the cache allocation method at S131 to S135 in the above embodiments is adopted, the candidate memory buffers are pre-sorted in the sequence, so the target memory buffer may be quickly determined according to the order of the buffers in the sequence; and, for buffers with different position requirements, they may also be screened in the sorted sequence, meeting diverse task requirements. In certain embodiments, when the cache allocation method at S141 to S145 in the above embodiments is adopted, there is no need for sorting, and only the refresh parameters of each candidate memory buffer are to be compared with a threshold. The calculation difficulty is low, and a general judge may be implemented, which has low requirements for the equipment and reduces the equipment cost; and, there is no need to perform sorting calculations, the amount of calculation is small, and the calculation cost is saved. Therefore, those skilled in the technical field may choose a suitable solution to implement according to different needs in actual use, and certain embodiments of the present disclosure do not impose restrictions on this.

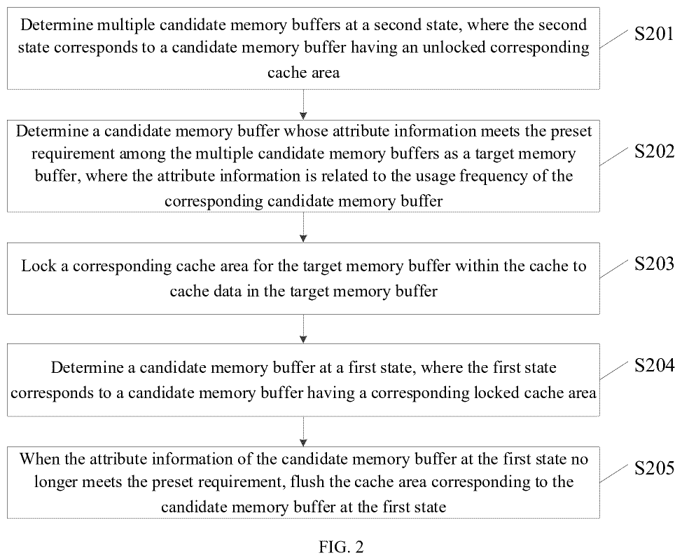

Certain embodiments of the present disclosure provide a cache allocation method, which is applied to an electronic device. FIG. 2 is a second schematic flow chart of an implementation of the cache allocation method according to certain embodiments of the present disclosure. As shown in FIG. 2, the method includes:

S201: Determine multiple candidate memory buffers at a second state, where the second state corresponds to a candidate memory buffer having an unlocked corresponding cache area.

In certain embodiments, the candidate memory buffers at the second state refer to candidate memory buffers in unlocked cache areas. The candidate memory buffers in the unlocked cache areas may be candidate memory buffers from cache areas that have never been locked, or may be candidate memory buffers that previously had corresponding locked cache areas but are currently flushed. Certain embodiments of the present disclosure do not impose restrictions on this.

S202: Determine a candidate memory buffer whose attribute information meets the preset requirement among the multiple candidate memory buffers as a target memory buffer, where the attribute information is related to the usage frequency of the corresponding candidate memory buffer;

S203: Lock a corresponding cache area for the target memory buffer within the cache to cache data in the target memory buffer;

S204: Determine a candidate memory buffer at a first state, where the first state corresponds to a candidate memory buffer having a corresponding locked cache area;

In certain embodiments, a flag bit may be set for each candidate memory buffer. For example, a flag bit of 1 indicates that the candidate memory buffer is at the first state, meaning that the buffer has a corresponding locked cache area. A flag bit of 0 indicates that the candidate memory buffer is at the second state, meaning that the corresponding cache area is not currently locked.

The first and second states of a candidate memory buffer may also be represented in other ways, and certain embodiments of the present disclosure do not impose restrictions on this.

S205: When the attribute information of the candidate memory buffer at the first state no longer meets the preset requirement, flush the cache area corresponding to the candidate memory buffer at the first state.

In certain embodiments of the present disclosure, when the corresponding cache area is locked for a candidate memory buffer within the cache, the buffer may be dynamically re-verified at predetermined intervals to determine whether it still meets the locking condition. If not, the corresponding cache area is flushed. Furthermore, buffers that previously did not meet the condition but whose attribute information currently meets the preset requirement may be locked, thereby implementing a dynamic on-chip storage model and significantly improving the data hit rate of the cache area.

The cache allocation method at S201 through S205 avoids cache ping-pong while dynamically adapting to the scenario, maximizing the utilization of the on-chip storage model portion of the cache.

In certain embodiments, the method includes:

S21: determine a screening condition based on the available size of the cache;

S22: determine a memory buffer that meets the screening condition as a candidate memory buffer.

In certain embodiments, the electronic device has multiple memory buffers. The method described at S21 and S22 may be used to identify candidate memory buffers that meet the screening condition from the multiple memory buffers. The cache allocation method described at S201 to S205 may then be performed on the candidate memory buffers that meet the screening condition.

In certain embodiments, S202, determining a target memory buffer whose attribute information meets the preset requirement among the multiple candidate memory buffers, includes:

S2021, determining a refresh parameter for each candidate memory buffer based on the attribute information of each candidate memory buffer;

S2022, determining the target memory buffer whose refresh parameter meets a first requirement.

Certain embodiments of the present disclosure further provides a cache allocation method. This cache allocation method utilizes system-level cache based on the refresh frequency of the display buffer.

The System Level Cache (SLC) is a module designed to share data between multiple DMA (Direct Memory Access) masters within a System on Chip (SOC). For example, after a graphics processing unit (GPU) completes rendering, it passes the data to the display unit (DPU) for display. After the image signal processing unit (ISP) completes video and photography, it shares the data with the embedded neural network processor (NPU) for neural network processing.

Among them, SLC may face the following challenges: Due to factors such as process and power consumption, system-level cache is often much smaller than DDR main memory. For example, the size of a system-level cache is typically several megabits or tens of megabits. DDR main memory is typically on the order of several gigabits or tens of gigabits. The system-level cache uses a strategy determined by the register transfer level (RTL) circuit to determine which data is cached (locked) in the SLC (for example, the corresponding cache area in the SLC is locked for certain data to cache that data) and which data is flushed (flushed) to the DDR. The optimized energy efficiency of the system-level cache is determined by the cache hit rate: the higher the cache hit rate, the greater the impact of the system-level cache on performance and power consumption, and vice versa.

When data is accessed in parallel and the total size of the data being accessed is larger than the SLC size, cache ping-pong often occurs. This means that data is frequently flushed to the DDR and read back into the SLC, resulting in low cache hit rates and impacting system power consumption and performance.

In certain embodiments, a buffer represents a memory segment used by the system, storing a system resource, such as the frame buffer, for the operating system.

For example, let's assume the system cache size is 8 MB. A user is playing a 1080p (pixel), 60 frames per second (FPS) game. The rendering engine and operating system typically allocate three frame buffers (Triple Buffers) for rendering and displaying the game. This ensures system smoothness and allows the GPU to render while the DPU displays the rendered results. The following timing sequence causes a ping-pong effect in the system cache:
1) The GPU completes rendering of the first frame's FrameBuffer, which is 1920×1080*4 (RGBA format)=8M bytes. At this point, the 8M SLC is completely occupied by this frame's data.
2) The GPU begins rendering the second frame's header. Since the second frame's FrameBuffer is newly generated data, the SLC is completely full, causing the first frame's header data to be flushed to the DDR.
3) The DPU begins displaying the first frame's data, reading from the header. At this point, the data has already been flushed to the DDR, and the DPU needs to read this data from the DDR.

When cache ping-pong occurs, all data reads and writes pass through the SLC. However, no data hits occur in the SLC, defeating its intended purpose and increasing system latency and power consumption.

To prevent SLC cache ping-pong, software may determine which buffers are locked into the SLC and ensure that the SLC always locks that memory, thus avoiding the ping-pong effect. This mode is called SLC On-Chip Memory mode (OCM mode).

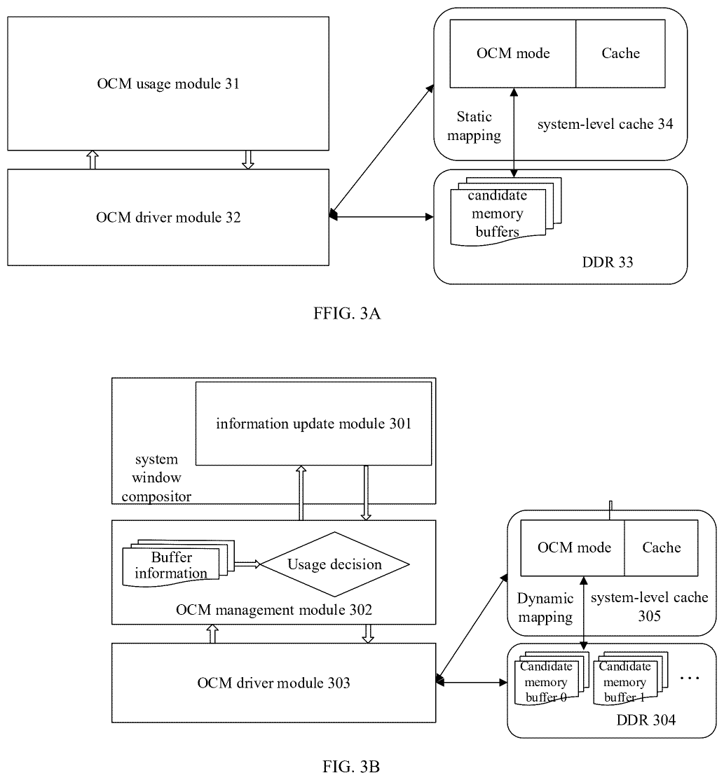

FIG. 3A is a schematic diagram of the working method of the OCM mode in certain related technology. As shown in FIG. 3A, the OCM mode in the related technology is a static mapping, including: an OCM usage module 31 and an OCM driver module 32, where, the OCM usage module 31 is used to decide which candidate memory buffers (for example, Buffers) to lock or flush, and the OCM driver module 32 is used to determine the available size of the cache area and perform operations such as locking the candidate memory buffers and releasing the candidate memory buffers. As may be seen from FIG. 3A, there are multiple candidate memory buffers in the DDR 33. In the system-level cache 34, the OCM mode may be used to statically lock the corresponding cache area for a candidate memory buffer to cache the data in the candidate memory buffer. That is, to avoid the ping-pong effect in the SLC, software may be used to determine which candidate memory buffer in the SLC to lock the corresponding cache area, and the SLC may be allowed to lock the cache area at all times, thereby avoiding the ping-pong effect in the SLC. This mode is the static OCM mode of the SLC.

For example, OCM may instruct the SLC to lock the first framebuffer, completely occupying the 8 MB cache for that frame. The data for the remaining two frames is directly transferred to DDR memory via the SLC. This results in a cache hit rate of ⅓ (33.3%) when rendering the three frames in turn, improving on the ping-pong effect.

However, OCM mode has the following issues: the memory (buffer) locked by OCM mode is often statically assigned by the OCM usage module (such as other driver modules in Linux). If the memory (buffer) is not frequently used, that is, the memory (buffer) needs to be read and written by each master (main processing module), OCM mode will not improve the SLC cache hit rate. On the contrary, because it occupies the system-level cache, it may cause the cache hit rate to decrease.

Furthermore, in desktop operating systems (such as Linux, Android, and Windows), the buffers that require frequent reads and writes are not fixed but constantly change based on user applications and scenarios. Therefore, embodiments of the present disclosure provide a mechanism to determine when to use OCM mode and which memory to lock in OCM mode, thereby improving the system-level cache hit rate.

In other words, embodiments of the present disclosure propose a cache allocation method that dynamically determines the use of OCM mode, designates and switches the buffers used in OCM mode, and thereby improves the cache hit rate of the SLC at the system level.

FIG. 3B is a schematic diagram of a working mode of the OCM mode in certain embodiments of the present disclosure. As shown in FIG. 3B, the OCM mode in certain embodiments of the present disclosure is a dynamic mapping mode, including: an information update module 301, an OCM management module 302, and an OCM driver module 303, where, the information update module 301 is used to report the information and time of candidate memory buffer usage. The OCM management module 302 is used to determine the usage strategy based on buffer information such as the size, format, and frequency of use of the candidate memory buffer, that is, to determine whether to use and which candidate memory buffer to use the OCM mode. The OCM driver module 303 is used to execute instructions issued by the user mode, and perform operations such as reserving the size, locking the candidate memory buffer, and releasing the candidate memory buffer. The information update module 301 is embedded in the system window compositor, a module within the operating system that performs desktop composition and display. This corresponds to Android's Surfaceflinger (a special process primarily responsible for compositing all Surfaces into a Framebuffer, which is then read by the screen and displayed to the user), Windows' Desktop Manager (a terminal management system), and Linux's X11 (a graphical window management system). As shown in FIG. 3B, DDR 304 contains multiple candidate memory buffers with different numbers, such as candidate memory buffer 0 and candidate memory buffer 1. The use of the OCM mode may be dynamically determined, and the buffer used by the OCM mode may be designated and switched, so that the OCM mode may be used in the system-level cache 305 to dynamically lock the corresponding cache area for a candidate memory buffer to cache the data in the candidate memory buffer; that is, the candidate memory buffer that may be locked by the SLC OCM is dynamically selected according to the situation of the candidate memory buffer. The selected candidate memory buffer usually has a suitable size and the highest refresh frequency in the system, that is, the GPU/NPU uses this block of memory at high speed, thereby ensuring that the cache hit rate of the SLC is improved.

In certain embodiments, this method includes the following modules:
(1) System buffer usage information update module: This module, embedded in the system window compositor, reports buffer usage information and time.
(2) OCM management module: This module determines whether to use a buffer and which buffer to use in OCM mode based on information such as the size, format, and frequency of use of the buffer.
(3) OCM kernel driver: This module executes instructions issued by the user mode, performs operations such as reserving the size, locking the memory, and releasing the memory.

In summary, the solution in certain embodiments of the present disclosure may dynamically select the OCM involved in the SLC according to the display buffer situation. The locked buffer and the selected buffer usually have a suitable size and the highest refresh frequency in the system, that is, the GPU and/or NPU use this block of memory at high speed, thereby ensuring that the cache hit rate of the SLC is improved.

In other words, the existing cache usage method uses the Register Transfer Level (RTL) circuit to determine which data enters and exits from the SLC based on time sequence, MPAM, and other information, without requiring much software intervention. However, this method may result in some frequently used data being frequently flushed in and out of the SLC, causing a ping-pong effect. The OCM mode in related technologies uses software to allocate an area in the SLC and lock a buffer. Once the buffer occupies the SLC, it is not automatically flushed by the hardware and requires software to actively trigger it. However, a buffer statically assigned to a scenario may not be used frequently after the scenario changes, resulting in a decrease in SLC utilization. In the OCM mode of certain embodiments of the present disclosure, the display management module of the Framework calculates the update rate of each display buffer, uses OCM for buffers that are updated as frequently as possible, and flushes out OCM for buffers that are less frequently used. This reduces the ping-pong effect while dynamically adapting to the scenario, maximizing the utilization of the OCM portion of the SLC.

The OCM mode in certain embodiments of the present disclosure is described in detail below. The OCM mode in certain embodiments of the present disclosure includes the following steps:
Step 1: Initialize the SLC and load the OCM driver module, enabling the OCM management module to obtain the SLC size and the available OCM size (OCM_A_Size) from the OCM driver module.
Step 2: The OCM management module sets the screening condition used by the information update module based on the available OCM size. The minimum size (Size_min) serves as an initial threshold. For example, the width and height of the buffer update area may be greater than the minimum size, such as 720×480 bytes, and the overall buffer size may be less than the available OCM size.
Step 3: the system passes the buffer information to the system window compositor for display synthesis. This buffer information includes size, format, resource identifiers (file descriptors in Linux), whether there are any updates, the size of the update area, and display-related information (such as whether to display, display location, and display transformations).
Step 4: the information update module screens the buffer information before the window compositor synthesizes and submits the appropriate buffer information to the OCM management module via IPC (inter-process communication). The screening condition includes at least one of the following:
A: The total size of this buffer block is less than or equal to the available size of the OCM;
B: This buffer block has been updated, and the size of the update area is greater than the minimum size;
C: This buffer block is used to store visible data (for example, the buffer visible to the user).
Step 5: The OCM management module updates the buffer information frequency table, which contains buffer information and buffer usage frequency. Buffer information is directly reported by the buffer usage information update module. The buffer usage frequency is a statistical summary of the buffer usage frequency for this block and may be calculated using the following formula:

[symbol]

When the buffer is updated, Buffer_Freq_Ins=10\hat{ }9/(Peroid_Current_ns);

When the buffer is not updated and Current_System_ns−Last ns>2*System_VSYNC_ns, Buffer_Freq_Ins=0;

Where, Buffer_Freq=Ratio*Buffer_Freq+(1.0-Ratio)*Buffer_Freq_Ins;

The physics definitions of the above parameters are as follows: System_VSYNC_ns is the system display refresh time (VYNC cycle) for the day; Current_ns is the current time the OCM management module receives the buffer update information; Last_ns is the time the OCM management module last received the buffer information; Ratio is the system-set threshold, a number between 0 and 1; Buffer_Freq is the calculated buffer usage frequency, with an initial value of 0.
Step 6: The OCM management module sorts the items in the buffer information frequency table, ranking them from high to low based on their scores. The score is calculated as Score=Buffer_Update_Size*Format_Bpp*Buffer_Freq.
Step 7, the OCM management module traverses the buffer information frequency table and makes a usage decision (strategy for locking/releasing the corresponding buffer's cache area). This usage decision is implemented as follows:

First, traverse buffers locked by the OCM (for example, buffers with a flag bit set to 1 in the table). If Score<Width_Min*Height_Min*Fromat_BPP*VSYNC_Freq*Refresh_Ratio, the OCM driver module flushes the buffer. This flushes the buffer to DDR memory, frees the corresponding OCM cache area, and increases the OCM's available size by the flushed size.

The second pass traverses buffers not locked by the OCM. When Score>=Width_Min*Height_Min*Fromat_BPP*VSYNC_Freq*Refresh_Ratio, and Buffer_Size<=OCM_A_Size, the OCM driver locks the buffer. This means moving the corresponding DDR memory into the OCM cache and subtracting Buffer_Size from OCM_A_SIZE.

In this calculation, VSYNC_Freq is the current refresh rate of the system's display (Hz), such as 30, 60, or 120; Width_Min and Height_Min are defined constants, such as Width_Min=720 and Height_Min=480; Format_BPP is the Bytes Per Pixel value of the buffer format, such as 4 for RGBA format and 1.5 for NV12 format; and Refresh_Ratio is a system-defined constant, typically between 0 and 0.4.

The above describes how the OCM management module dynamically locks and flushes buffers based on their refresh rate information. This process ensures that buffers with high refresh rates use OCM and buffers with low refresh rates are flushed from OCM, thereby maximizing SLC utilization.

For example, suppose an Android user starts playing a game and then switches to the camera preview function, pausing the game in the background. The OCM mode used in related technology is a static OCM solution, where the game's FB does not automatically flush OCM after using it. However, the OCM mode used in certain embodiments is a dynamic OCM solution, where the game's OCM is flushed to the foreground application after the game is switched to the background.

Certain embodiments of the present disclosure provide a cache allocation device. This device includes various modules, units within each module, and components within each unit. This device may be implemented using a processor within an electronic device; however, it may also be implemented using a specific logic circuit. During implementation, the processor may be a CPU (Central Processing Unit), an MPU (Microprocessor Unit), a DSP (Digital Signal Processing Unit), or an FPGA (Field Programmable Gate Array).

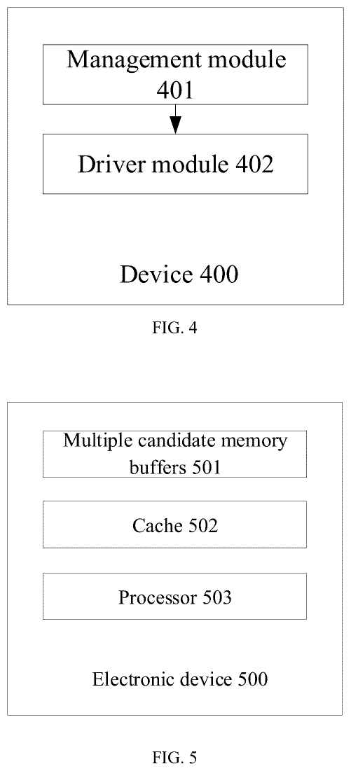

FIG. 4 is a schematic diagram of the structure of the cache allocation device according to certain embodiments of the present disclosure. As shown in FIG. 4, the device 400 includes:

A management module 401, configured to identify multiple candidate memory buffers of an electronic device; and to identify a candidate memory buffer whose attribute information meets preset requirement as a target memory buffer, where the attribute information is related to the usage frequency of the candidate memory buffer.

A driver module 402, configured to lock a corresponding cache area within the system-level cache of the electronic device for the target memory buffer to cache data within the target memory buffer.

In certain embodiments, the device further includes:

A first determination module, configured to determine a candidate memory buffer at a first state, where the first state corresponds to a candidate memory buffer having a corresponding locked cache area.

A flush module, configured to flush the cache area corresponding to the candidate memory buffer at the first state when the attribute information of the candidate memory buffer at the first state no longer meets the preset requirement.

In certain embodiments, the management module 401 includes:

The management submodule, configured to determine multiple candidate memory buffers at a second state, where the second state corresponds to a cache area corresponding to the candidate memory buffer not being locked.

In certain embodiments, the device further includes:
a second determination module, configured to determine a screening condition based on the available size of the cache;
a third determination module, configured to determine a memory buffer that meets the screening condition as a candidate memory buffer.

In certain embodiments, the screening condition includes at least one of:

The size of the memory buffer is less than or equal to a first preset size, where the first preset size is the available size of the cache;

An update occurs in the memory buffer;

The size of the update area of the memory buffer is greater than or equal to a second preset size;

The memory buffer is used to store data to be displayed.

In certain embodiments, the management module 401 includes:
a first determination unit, configured to determine a refresh parameter for each candidate memory buffer based on attribute information of each candidate memory buffer;
a second determination unit, configured to determine a candidate memory buffer whose refresh parameter meets the first requirement as the target memory buffer.

In certain embodiments, the second determination unit includes:
a sorting component, configured to sort the multiple candidate memory buffers according to the refresh parameter to obtain a sorting result;

A first determination component, configured to, based on the sorting result, determine a candidate memory buffer whose sorting position meets a second requirement as the target memory buffer.

In certain embodiments, the second determination unit includes:

A second determination component, configured to determine a refresh parameter threshold based on storage properties of the electronic device;

A third determination component, configured to determine a candidate memory buffer whose refresh parameter is greater than or equal to the refresh parameter threshold as the target memory buffer.

In certain embodiments, the attribute information includes at least one of: a memory buffer update frequency, a memory buffer update area size, and a pixel byte value format of the memory buffer;

In certain embodiments, the first determination unit includes:

A first determination subunit, configured to determine a refresh parameter for each candidate memory buffer based on at least one of an update frequency of each candidate memory buffer, a size of an update region of each candidate memory buffer, and pixel byte values in the format of each candidate memory buffer.

Certain embodiments of the present disclosure provide an electronic device. FIG. 5 is a schematic diagram of a structure of the electronic device according to certain embodiments of the present disclosure. As shown in FIG. 5, the electronic device 500 includes:
Multiple candidate memory buffers 501;
Cache 502;
Processor 503, configured to determine the multiple candidate memory buffers 501; determine a candidate memory buffer among the multiple candidate memory buffers 501 whose attribute information meets preset requirement as a target memory buffer, wherein the attribute information is related to the usage frequency of the corresponding candidate memory buffer; and lock a corresponding cache area within the cache 502 for the target memory buffer to cache data in the target memory buffer.

The descriptions of the above device embodiments are similar to the descriptions of the above method embodiments and have similar beneficial effects as the method embodiments. For technical details not disclosed in the device embodiments of the present disclosure, reference may be made the descriptions of the method embodiments of the present disclosure for understanding.

In certain embodiments of the present disclosure, when the cache allocation method described above is implemented as a software functional module and sold or used as a standalone product, it may also be stored in a computer-readable storage medium. Based on this understanding, the technical solution of certain embodiments of the present disclosure may be embodied in the form of a software product. This computer software product, stored in a storage medium, includes instructions for enabling an electronic device (such as a personal computer or server) to perform all or part of the methods described in the various embodiments of the present disclosure. The aforementioned storage medium includes various media capable of storing program code, such as a USB flash drive, a mobile hard drive, ROM (Read Only Memory), a magnetic disk, or an optical disk. Thus, certain embodiments of the present disclosure do not impose restrictions on any combination of hardware and software.

Certain embodiments of the present disclosure further provide an electronic device including a memory and a processor. The memory stores a computer program executable on the processor. When the processor executes the program, it implements the steps of the cache allocation method provided in the above embodiments.

Certain embodiments of the present disclosure provide a readable storage medium having a computer program stored thereon. When executed by a processor, the computer program implements the steps of the aforementioned cache allocation method.

The descriptions of the above storage medium and device embodiments are similar to the descriptions of the above method embodiments and have similar beneficial effects as the method embodiments. For technical details not disclosed in the storage medium and device embodiments of the present disclosure, reference may be made to the descriptions of the method embodiments of the present disclosure for an understanding.

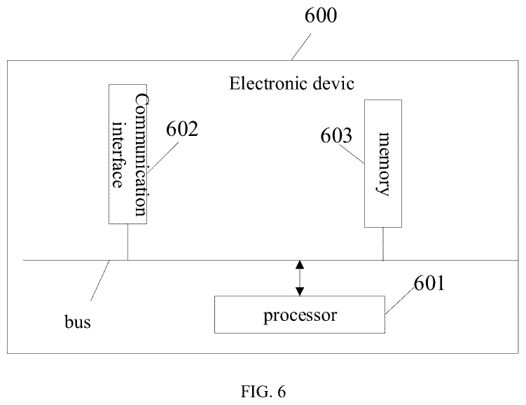

FIG. 6 is a schematic diagram of the hardware of an electronic device according to certain embodiments of the present disclosure. As shown in FIG. 6, the hardware of electronic device 600 includes a processor 601, a communication interface 602, and a memory 603.

Processor 601 generally controls the overall operation of electronic device 600.

Communication interface 602 enables electronic device 600 to communicate with other electronic devices, servers, or platforms via a network.

Memory 603 is configured to store instructions and applications executable by processor 601. It may also cache data to be processed or processed by processor 601 and various modules in electronic device 600 (for example, image data, audio data, voice communication data, and video communication data). This may be implemented using FLASH (flash memory) or RAM (random access memory).

In certain embodiments, the disclosed devices and methods may be implemented in other ways. The device embodiments described above are illustrative. For example, the division of units described is a logical functional division. In implementation, other divisions may be used, such as combining multiple units or components or integrating them into another system, or omitting or disabling certain features. Furthermore, the coupling, direct coupling, or communication connection between the various components shown or discussed may be through interfaces. Indirect coupling or communication connections between devices or units may be electrical, mechanical, or other forms.

The units described above as separate components may or may not be physically separate, and the components shown as units may or may not be physical units, that is, they may be located in a single location or distributed across multiple network units. Some or all of these units may be selected based on actual needs to achieve the objectives of certain embodiments.

In addition, the functional units in the various embodiments of the present disclosure may be integrated into a single processing module, each unit may be independently configured as a unit, or two or more units may be integrated into a single unit. These integrated units may be implemented in hardware or as hardware plus software functional units. Those skilled in the technical field appreciate that all or part of the steps of the above method embodiments may be performed by hardware associated with program instructions. The aforementioned program may be stored in a computer-readable storage medium, which, when executed, performs the steps of the above method embodiments. The aforementioned storage medium includes various media capable of storing program code, such as removable storage devices, ROM, RAM, magnetic disks, or optical disks.

The methods disclosed in the several method embodiments provided in the present disclosure may be combined in any way, unless they conflict with each other, to produce new method embodiments.

The features disclosed in the several product embodiments provided in the present disclosure may be combined in any way, unless they conflict with each other, to produce new product embodiments.

The features disclosed in the several method or device embodiments provided in the present disclosure may be combined in any way, unless they conflict with each other, to produce new method or device embodiments.

The above descriptions reflect certain embodiments of the present disclosure, but the scope of protection of the present disclosure is not restricted to the descriptions. Any modifications or substitutions that may be readily conceived by a person skilled in the technical field within the technical scope disclosed in the present disclosure are to be covered by the scope of protection of the present disclosure. Therefore, the scope of protection of the present disclosure shall be based on the scope of protection of the claims.

What is claimed is:

1. A cache allocation method, comprising:
determining multiple candidate memory buffers;
determining a target memory buffer among the multiple candidate memory buffers whose attribute information meets a preset requirement, wherein the attribute information is related to a usage frequency of corresponding candidate memory buffer; and
locking a corresponding cache area within a cache for the target memory buffer to cache data in the target memory buffer.

2. The method of claim 1, further comprising:
determining a candidate memory buffer at a first state, wherein the first state corresponds to a candidate memory buffer having a corresponding locked cache area;
in response to determining that the attribute information of the candidate memory buffer at the first state no longer meets the preset requirement, releasing the cache area corresponding to the candidate memory buffer at the first state; and
determining multiple candidate memory buffers includes:
determining multiple candidate memory buffers at a second state, wherein the second state corresponds to a candidate memory buffer having an unlocked cache area.

3. The method of claim 1, further comprising:
determining a screening condition based on an available size of the cache; and
determining a memory buffer that meets the screening condition as a candidate memory buffer.

4. The method of claim 3, wherein the screening condition includes one or more of:
the size of the memory buffer is less than or equal to a first preset size, wherein the first preset size is the available size of the cache;
an update exists in the memory buffer;
a size of an update area of the memory buffer is greater than or equal to a second preset size; and
the memory buffer is used to store data to be displayed.

5. The method of claim 1, wherein determining the target memory buffer whose attribute information meets the preset requirement includes:
determining, based on the attribute information of each candidate memory buffer, a refresh parameter for each candidate memory buffer; and
determining the target memory buffer whose refresh parameter meets a first requirement.

6. The method of claim 5, wherein determining the target memory buffer whose refresh parameter meets a first requirement includes:
sorting the multiple candidate memory buffers according to the refresh parameter to obtain a sorting result; and
based on the sorting result, determining the target memory buffer whose sorting position meets a second requirement.

7. The method of claim 5, wherein determining the target memory buffer whose refresh parameters meet the first requirement includes:
determining a refresh parameter threshold based on storage properties of the electronic device; and
determining the candidate memory buffer whose refresh parameters are greater than or equal to the refresh parameter threshold as the target memory buffer.

8. The method of claim 5, wherein the attribute information includes at least one of: a memory buffer update frequency, a memory buffer update area size, and a memory buffer format pixel byte value;
determining the refresh parameters of each candidate memory buffer based on the attribute information of each candidate memory buffer includes:
determining the refresh parameters of each candidate memory buffer based on at least one of:
update frequency of each candidate memory buffer, update area size of each candidate memory buffer, and format pixel byte value of each candidate memory buffer.

9. An electronic device, comprising: a memory storing computer program instructions; and a processor coupled to the memory and configured to execute the computer program instructions and perform:
determining multiple candidate memory buffers;
determining a target memory buffer among the multiple candidate memory buffers whose attribute information meets a preset requirement, wherein the attribute information is related to a usage frequency of corresponding candidate memory buffer; and
locking a corresponding cache area within a cache for the target memory buffer to cache data in the target memory buffer.

10. The electronic device of claim 9, wherein the processor is further configured to perform:
determining a candidate memory buffer at a first state, wherein the first state corresponds to a candidate memory buffer having a corresponding locked cache area;
in response to determining that the attribute information of the candidate memory buffer at the first state no longer meets the preset requirement, releasing the cache area corresponding to the candidate memory buffer at the first state; and
determining multiple candidate memory buffers includes:
determining multiple candidate memory buffers at a second state, wherein the second state corresponds to a candidate memory buffer having an unlocked cache area.

11. The electronic device of claim 9, wherein the processor is further configured to perform:
determining a screening condition based on an available size of the cache; and
determining a memory buffer that meets the screening condition as a candidate memory buffer.

12. The electronic device of claim 11, wherein the screening condition includes one or more of:
the size of the memory buffer is less than or equal to a first preset size, wherein the first preset size is the available size of the cache;
an update exists in the memory buffer;
a size of an update area of the memory buffer is greater than or equal to a second preset size; and
the memory buffer is used to store data to be displayed.

13. The electronic device of claim 9, wherein determining the target memory buffer whose attribute information meets the preset requirement includes:
determining, based on the attribute information of each candidate memory buffer, a refresh parameter for each candidate memory buffer; and
determining the target memory buffer whose refresh parameter meets a first requirement.

14. The electronic device of claim 13, wherein determining the target memory buffer whose refresh parameter meets a first requirement includes:
sorting the multiple candidate memory buffers according to the refresh parameter to obtain a sorting result; and
based on the sorting result, determining the target memory buffer whose sorting position meets a second requirement.

15. The electronic device of claim 13, wherein determining the target memory buffer whose refresh parameters meet the first requirement includes:
determining a refresh parameter threshold based on storage properties of the electronic device; and
determining the candidate memory buffer whose refresh parameters are greater than or equal to the refresh parameter threshold as the target memory buffer.

16. The electronic device of claim 13, wherein the attribute information includes at least one of: a memory buffer update frequency, a memory buffer update area size, and a memory buffer format pixel byte value;
determining the refresh parameters of each candidate memory buffer based on the attribute information of each candidate memory buffer includes:
determining the refresh parameters of each candidate memory buffer based on at least one of:
update frequency of each candidate memory buffer, update area size of each candidate memory buffer, and format pixel byte value of each candidate memory buffer.

17. A non-transitory computer-readable storage medium storing computer program instructions executable by at least one processor to perform:
determining multiple candidate memory buffers;
determining a target memory buffer among the multiple candidate memory buffers whose attribute information meets a preset requirement, wherein the attribute information is related to a usage frequency of corresponding candidate memory buffer; and
locking a corresponding cache area within a cache for the target memory buffer to cache data in the target memory buffer.

18. The non-transitory computer-readable storage medium of claim 17, wherein the computer program instructions are further executable by the at least one processor to perform:
determining a candidate memory buffer at a first state, wherein the first state corresponds to a candidate memory buffer having a corresponding locked cache area;
in response to determining that the attribute information of the candidate memory buffer at the first state no longer meets the preset requirement, releasing the cache area corresponding to the candidate memory buffer at the first state; and
determining multiple candidate memory buffers includes:
determining multiple candidate memory buffers at a second state, wherein the second state corresponds to a candidate memory buffer having an unlocked cache area.

19. The non-transitory computer-readable storage medium of claim 17, wherein the computer program instructions are further executable by the at least one processor to perform:
determining a screening condition based on an available size of the cache;
determining a memory buffer that meets the screening condition as a candidate memory buffer.

20. The non-transitory computer-readable storage medium of claim 19, wherein the screening condition includes one or more of:
the size of the memory buffer is less than or equal to a first preset size, wherein the first preset size is the available size of the cache;
an update exists in the memory buffer;
a size of an update area of the memory buffer is greater than or equal to a second preset size; and
the memory buffer is used to store data to be displayed.
